(19) United States
(12) Patent Application Publication
(10) Pub. No.: US 2010/0142222 A1
(43) Pub. Date: Jun. 10, 2010

(54) Light guide with refractive layer

(75) Inventor: Mahyar Vahabzadeh, Scottsdale, AZ (US)

Correspondence Address: Paul F. Wille;Cantor Colburn LLP, 2nd Floor, 20 Church St., Hartford, CT, 06103-3207, US

(73) Assignee: World Properties, Inc., Lincolnwood, IL (US)

(21) Appl. No.: 12/315,582

(22) Filed: Dec. 4, 2008

(51) Int. Cl. F21V 7/04

(52) U.S. Cl. 362/615

(57) ABSTRACT

A layer having a refractive index less than that of a light guide can be used as a refractive layer, rather than a reflective layer, for increasing light output. The effect is improved if the refractive layer is patterned to correspond to light extracting features on the surface of the light guide. The refractive layer and the light extracting features are on opposed surfaces of the light guide. The refracting layer can be deposited from ink at relatively low cost.

### CROSS-REFERENCE TO RELATED APPLICATION

This application relates to U.S. application Ser. No. 12/009,060, filed Jan. 16, 2008, and entitled Luminous Touch Screen with Interstitial Layer. The contents of the filed application are incorporated by reference into this application.

### FIELD OF THE INVENTION

This invention relates to light guides for back lighting displays, keypads, or other parts of electronic devices and, in particular, relates to a light guide having a refractive layer. The invention can also be a source of illumination.

### BACKGROUND OF THE INVENTION

Edge lit sheets, or light guides, for back lighting have long been known in the art; e.g. U.S. Pat. Nos. 3,027,669 (Hardesty) and 3,356,839 (Mehess et al.). Edge lit keypads are also known in the art. For example, U.S. Pat. No. 4,247,747 (Swatten) discloses light emitting diodes (LEDs) optically coupled to a polyester sheet having a thickness of seven mils (0.18 mm). U.S. Pat. No. 5,975,711 (Parker et al.) discloses a light conductive panel coupled to a light source.

Edge lit sheets conduct light from an edge, relying mostly on what is known as total internal reflection. (There is also some direct transmission). Total internal reflection is obtained when light is incident upon a surface at greater than a critical angle, measured from perpendicular or “normal” to the surface. Air is typically used around light guides but separation makes construction awkward. It is known to use a reflecting layer, such as aluminum, as a “cladding layer” to simulate total internal reflection in light guides. Published Patent Application 2005/0210643 (Mezei et al.) discloses using white or “reflecting” paint for a reflector. Published Patent Application 2004/0251567 (Cappellini et al.) discloses Superflex® 2500 resin as a cladding material for optical fiber and discloses that the resin has a refractive index of 1.35-1.41.

U.S. Pat. No. 3,700,802 (Markin et al.) discloses that material surrounding an optical fiber (light pipe) “may simply be air, although the pipe usually is sheathed or clad with a substance exhibiting an intermediate index of refraction in order to obviate losses where the pipe otherwise would touch some other material or substance.” This represents the conventional wisdom in the art wherein the layer on or around a light guide is considered in terms of maintaining total internal reflection.

A similar thought is expressed in U.S. Pat. No. 5,995,690 (Kotz et al.), which goes further and describes a light extracting element as having an index of refraction that is the same or greater than the index of refraction of the fiber core. The cladding is removed in certain areas to provide access to the core for the light extracting element.

A light extracting feature interferes with total internal reflection. One or more such features are located on a major surface of a sheet for lighting discrete areas. Alternatively, an entire surface can be used to extract light. U.S. Pat. No. 4,183,628 (Laesser et al.) discloses a watch that is back lit by a light source coupled to the edge of a “frost glass” having scratches on its lower surface to redirect light up through a display. U.S. Pat. No. 5,550,676 (Ohe et al.) discloses an edge lit light guide having graduated features to compensate for distance from a light source.

Screen printing is long known in the art for making a variety of products, such as electroluminescent (EL) lamps. The inks used for making EL lamps include a binder, a solvent, and a filler, wherein the filler determines the nature of the ink (e.g. carbon for conductive layers, barium titanate for dielectric layers). The inks are printed and cured (dried) to form each layer in an EL lamp.

In view of the foregoing, it is therefore an object of the invention to provide improved extraction of light from a light guide.

Another object of the invention is to provide a refractive layer for extracting light from a light guide.

A further object of the invention is to provide a patterned refractive layer for further improving extracting light from a light guide.

Another object of the invention is to provide a refractive layer that can be printed from ink at relatively low manufacturing cost.

### SUMMARY OF THE INVENTION

The foregoing objects are achieved by this invention in which it has been discovered that a layer having a refractive index less than that of a light guide can be used as a refractive layer, rather than a reflective layer, for increasing light output. It has further been discovered that the effect is improved if the refractive layer is patterned to correspond to light extracting features on the surface of the light guide. The refractive layer and the light extracting features are on opposed surfaces of the light guide. The refracting layer can be deposited from ink at relatively low cost.

### BRIEF DESCRIPTION OF THE DRAWINGS

A more complete understanding of the invention can be obtained by considering the following detailed description in conjunction with the accompanying drawings, in which:

FIG. 1 illustrates Snell's Law;

FIG. 2 is a cross-section of a light guide constructed in accordance with the invention;

FIG. 3 is a cross-section of a light guide constructed in accordance with a preferred embodiment of the invention; and

FIG. 4 is a perspective view of a cellular telephone having a back lit user interface constructed in accordance with the invention.

### DETAILED DESCRIPTION OF THE INVENTION

As known in the art, Snell's Law can be written as follows.

$$\frac{sin {θ}_{1}}{sin {θ}_{2}} = \frac{{n}_{2}}{{n}_{1}} \qquad ( 1 )$$

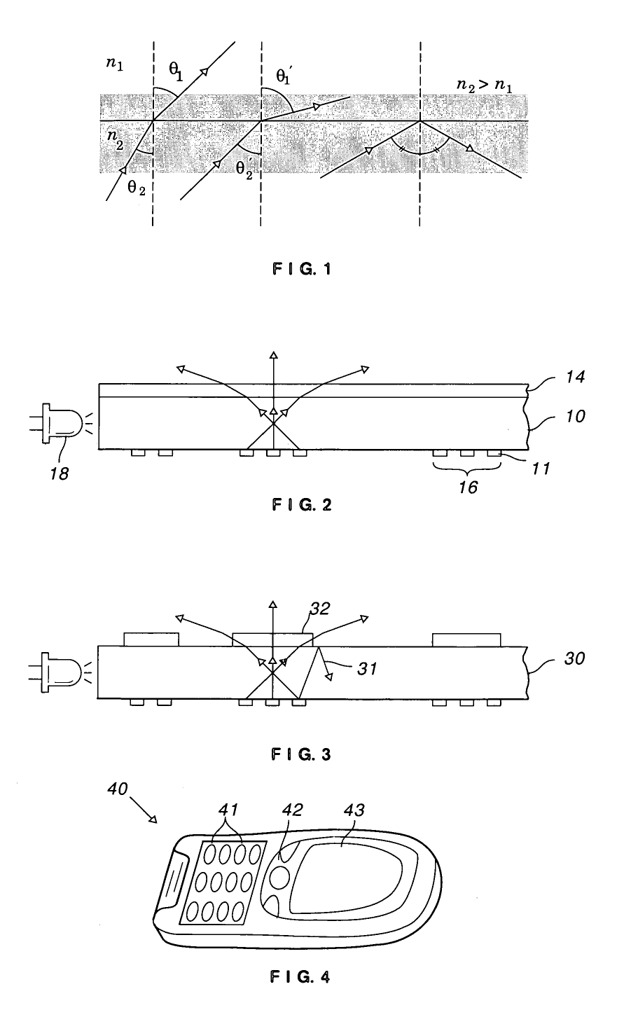

In FIG. 1, n₂>n₁, for example, representing an air (n₁=1) to water (n₂=1.33) interface. As can be seen by inspection of equation (1), as θ₂ increases, θ₁ increases more rapidly, in proportion to n₂/n₁. At some point (θ₁=90°), light no longer escapes from the surface of the water but travels through the boundary between air and water. Further increases in θ₂ cause light to be reflected downward at the boundary.

If one increases n₂ to 1.6, for example, θ₁ increases even more rapidly with increases in θ₂. In other words, critical angle decreases with increasing n₂. For containing light within a light guide, this is desirable. Conversely, if n₁ increases, the critical angle increases, which is undesirable for containing light.

It is known in the art to have light extracting means, such as a deformation of the surface, on the side from which light is to be emitted from the light guide. Typically, a reflective layer is on the opposite surface of the light guide from the light emitting surface.

In accordance with the invention, as illustrated in FIG. 2, light guide 10 includes light extracting features, such as at site 11, for dispersing incident light. Light is reflected upward toward refracting layer 14, which has an index of refraction less than light guide 10 and greater than air. Light is refracted at the boundary between light guide 10 and refracting layer 14 and is again refracted at the boundary between refracting layer 14 and air. As a result, the light from each group of light extracting features, such as group 16, is combined and spread. A group of extracting features can produce uniform backlighting by adding a diffuse interface element overlying layer 14 above group 16.

Light guide 10 is preferably a sheet of polycarbonate (n≈1.58) approximately 0.18 mm thick. The light extracting feature is preferably a dot of cured or dried resin containing light dispersing particles, such as barium titanate or titanium dioxide. The dots are preferably applied by screen printing. Refracting layer 14 is an adherent polymer layer, such as PMMA (polymethyl methacrylate) (n≈1.49), which can also be applied by screen printing, roll coating, and other techniques. A thickness of 0.015 mm or less is preferred but not required.

Light from a suitable source 18 is coupled into at least one edge of light guide 10 and transmitted across the light guide, primarily by total internal reflection. Surface mounted, side emitting LEDs are preferred as the light source for small, e.g. hand held, devices. Other kinds of light sources can be used instead.

FIG. 3 illustrates a preferred embodiment of the invention in which the refracting layer is patterned to form islands corresponding to the pattern of groups of dots. The islands preferably have an area slightly greater than the area of the corresponding group of dots. A group of dots and the corresponding island can have any desired shape and the shapes need not be similar. The construction of this embodiment is otherwise the same as the embodiment illustrated in FIG. 2. As indicated by ray 31, island 32 localizes the emission of light. Light not incident on the boundary between island 32 and light guide 30 is internally reflected because the critical angle is smaller outside the boundary.

Contrary to expectations, the embodiment illustrated in FIG. 3 provided a brighter back light than the embodiment illustrated in FIG. 2. Specifically, a light guide with dots on the reverse side (the side away from light emission) and no refractive layer on the front side had a brightness of 15.8 ft/L. A light guide with a “flood” refractive layer (no pattern, e.g. roll coated) had a brightness of 19.0 ft/L. A light guide with a patterned refractive layer had a brightness of 23.3 ft/L. The samples differed only in the refractive layers and brightness was measured at corresponding locations on the samples.

FIG. 4 is a perspective view of a cellular telephone, one of the many devices in which a user interface can be back lit in accordance with the invention. The user interface in cellphone 40 includes keypad 41, control sensors 42, and window 43 for displaying text or graphics. Groups of dots back light the keys in keypad 41. Visual separation of the keys is enhanced by having a separate group of dots for each key. The keys can be membrane switches or touch sensitive devices, such as capacitive switches. Control sensors 42 are touch sensitive devices. All are compatible with a back light constructed in accordance with the invention.

The invention thus provides improved, low cost back light. Extraction of light from a light guide is improved by using a refractive layer on a first major surface of a light guide and light extracting features on a second major surface of the light guide. A patterned refractive layer further improves extraction of light. The refractive layer can be deposited from an ink and appears flat to the unaided eye. That is, the refractive properties do not require a lenticular layer or island.

Having thus described the invention, it will be apparent to those of skill in the art that various modifications can be made within the scope of the invention. For example, dyes, or other agents, can be added to the light extracting features to affect the extracted light. Optical coupling can be used to gather more light into the light guide from the light source. Depending upon need, e.g. because of limited space, light can be reflected from a source prior to entering the light guide.

What is claimed is:

1. A light guide in the form of an edge lit sheet having light extracting features on a first surface characterized in that
the light guide has an index of refraction, n₁;
a refractive layer overlies a second surface of the light guide;
the refractive layer has an index of refraction, n₂; wherein n₁>n₂>1.

2. The light guide as set forth in claim 1 wherein the refractive layer is patterned to form at least one island.

3. The light guide as set forth in claim 2 wherein the light extracting features are groups of dots on the first surface and the refracting layer includes islands positioned corresponding to the groups of dots, whereby an island combines and disperses light emitted by the dots in a group.

4. The light guide as set forth in claim 3 wherein the area of an island is larger than the area of the corresponding group of dots.

5. The light guide as set forth in claim 3 wherein the dots are screen printed on the first surface and the islands are screen printed on the second surface.

6. In a hand held electronic device having a back lit user interface, the improvement comprising:
a back light in the form of an edge lit sheet having an index of refraction, n₁, and having light extracting features on a first surface of the sheet;
a refractive layer overlying a second surface of the sheet; wherein the refractive layer has an index of refraction, n₂; and
wherein n₁>n₂>1.

7. The hand held electronic device as set forth in claim 6 wherein the refractive layer is patterned to form at least one island corresponding to at least a portion of said interface.

8. The hand held electronic device as set forth in claim 7 wherein the light extracting features are groups of dots on the first surface and the refracting layer includes islands positioned corresponding to the groups of dots, whereby an island combines and disperses light emitted by the dots in a group.
